(19) United States
(12) Patent Application Publication
(10) Pub. No.: US 2024/0261742 A1
(43) Pub. Date: Aug. 8, 2024

(54) MODULAR MIXING IMPELLER

(71) Applicant: Parker-Hannifin Corporation, Cleveland, OH (US)

(72) Inventor: Brendan J. Schuler, West Hollywood, CA (US)

(73) Assignee: Parker-Hannifin Corporation, Cleveland, OH (US)

(21) Appl. No.: 18/106,282

(22) Filed: Feb. 6, 2023

Related U.S. Application Data
(63) Continuation of application No. PCT/US2021/053196, filed on Oct. 1, 2021.
(60) Provisional application No. 63/086,628, filed on Oct. 2, 2020.

(51) Int. Cl. B01F 27/1152; B01F 27/1151; B01F 27/191; B01F 27/2111; B01F 27/2124

(52) U.S. Cl. CPC B01F 27/1152; B01F 27/1151; B01F 27/191; B01F 27/2111; B01F 27/2124

(57) ABSTRACT

A modular mixing impeller assembly that includes one or more connection tubes, and one or more impellers configured for assembly to the one or more connection tubes. Each of the one or more impellers has a plurality of mixing blades. Each of the one or more impellers is assembled onto at least one connection tube via a friction fit such that each of the one or more impellers is configured to rotate with its attached connection tube, and wherein the assembly between impeller and connection tube creates an airtight and water-tight seal.

### CROSS-REFERENCE TO RELATED PATENT APPLICATIONS

This patent application is a continuation of U.S. PCT Patent Application No. PCT/US2021/053196, filed Oct. 1, 2021, which is now pending, which claims the benefit of U.S. Provisional Patent Application No. 63/086,628, filed Oct. 2, 2020, the entire teachings and disclosure of which are incorporated herein by reference thereto.

### FIELD OF THE INVENTION

This invention generally relates to an apparatus for mixing of ingredients, such as those in the pharmaceutical or life sciences industry.

### BACKGROUND OF THE INVENTION

Within certain industries, such as the life sciences industry, ensuring fluidic products remain free of outside contaminates is crucial for producing high quality products. These products are often born from the combination of a variety of refined materials that are forcibly mixed to produce the desired results. As such, these products require highly specialize mixing processes to ensure that they achieve optimal mixing results without contaminating, or otherwise damaging, the product during the mixing process.

Most mixing systems designed for use with sterile containers use a magnetic stir bar and spin plate combination, where a cylindrical magnetic is placed at the bottom of the container and spins as it interacts with a specialized plate placed underneath the container. The spinning action of the stir bar mixes materials inside of the container. However, these systems are typically limited to sizes of 50 liters and under to ensure adequate mixing. Larger systems often require that either the container to be opened to insert a mixing probe, which requires specialized cleaning after each use, or that they use a pre-installed impeller centered close to the top, bottom or edge of the container. Most of these mixing systems are designed with a singular impeller, whose mixing potential greatly decreases as the container sizes increase.

Embodiments of the invention disclosed herein address some of the shortcomings detailed above. These and other advantages of the invention, as well as additional inventive features, will be apparent from the description of the invention provided herein.

### BRIEF SUMMARY OF THE INVENTION

In one aspect, embodiments of the invention provide a modular mixing impeller assembly that includes one or more connection tubes, and one or more impellers configured for assembly to the one or more connection tubes. Each of the one or more impellers has a plurality of mixing blades. Each of the one or more impellers is assembled onto at least one connection tube via a friction fit such that each of the one or more impellers is configured to rotate with its attached connection tube, and wherein the assembly between impeller and connection tube creates an airtight and water-tight seal.

In a particular embodiment, each of the one or more impellers includes a central hub with a bore hole therethrough, the bore hole configured to accommodate a drive shaft. In certain embodiments, a first side of the central hub extends axially away from the plurality of mixing blades in a first direction, and a second side of the central hub extends away from the plurality of mixing blades in a second direction opposite the first direction.

The first side of the central hub may include a hosebarb to facilitate attachment to one of the one or more connection tubes.

Similarly, the second side of the central hub may also include a hosebarb to facilitate attachment to one of the one or more connection tubes.

At least one of the one or more impellers may include a plate section that extends radially outward from the central hub, and wherein each of the plurality of mixing blades is attached at a perimeter portion of the plate section.

In particular embodiments, each of the plurality of mixing blades is pitched at an angle to the plate section such that rotation of the blades in a clockwise direction forces a mixture to flow axially in a first direction, and rotation of the blades in a counterclockwise direction forces the mixture to flow axially in a second direction opposite the first direction.

In alternate embodiments, each of the plurality of mixing blades is attached perpendicularly to the plate section such that rotation of the blades in a clockwise or counterclockwise direction forces a mixture to flow radially outward from the blades.

Furthermore, in some embodiments, the plate section has a one or more openings. For example, the plate section may have three openings spaced 120 degrees apart around a circumference of the plate section, or four openings spaced 90 degrees apart around the circumference of the plate section, or six openings spaced 60 degrees apart around the circumference of the plate section.

In certain embodiments, each pair of adjacent impellers is connected via a separate connection tube.

Furthermore, in particular embodiments, a length of the one or more connection tubes is variable such that a number of impellers used, for a given application, can be increased or decreased by varying the length of the one or more connection tubes.

The plurality of impellers may be arranged in a series configuration, with each impeller disposed in axial spaced relation to an adjacent mixing blade. In such an arrangement, a length of the sealed tube may be variable such that the modular mixing impeller assembly can be configured to include a variable number of impellers.

The assembly may further include a drive shaft inserted through the one or more connection tubes and through a bore hole of each of the one or more impellers, the drive shaft configured for connection to an external motor that rotates the drive shaft.

The drive shaft may slideably key to the bore hole such that the size and shape of the drive shaft cross-section matches size and shape of the cross-section of the bore hole. For example, the drive shaft may have a hexagonal cross-section (or other polygonal and/or non-circular cross-section) that corresponds to a hexagonal cross-section (or other polygonal and/or non-circular cross-section) for each bore hole of the one or more impellers such that rotation of the drive shaft rotates each of the one or more impellers, and each of the one or more connection tubes.

In some embodiments, at least one of the one or more connection tubes is made from a flexible material. The flexible material may be plastic, for example. Preferably, the one or more connection tubes is made from a transparent material.

In another aspect, embodiments of the invention provide a modular mixing impeller that includes a central hub with a bore hole therethrough. The bore hole may be configured to accommodate, and be rotatably coupled to, a drive shaft that is slideably keyed to the bore hole, for example. The central hub is configured for a sealed connection to at least one connection tube. A plate section extends radially outward from the central hub, and a plurality of mixing blades is attached at a perimeter portion of the plate section.

In a particular embodiment, a first side of the central hub extends axially away from the plurality of mixing blades in a first direction, and a second side of the central hub extends away from the plurality of mixing blades in a second direction opposite the first direction. Preferably, the first and second sides of the central hub are each configured for assembly to the at least one connection tube via a friction fit such that the impeller is configured to rotate with the at least one connection tube, such that the assembly between impeller and connection tube creates an airtight and water-tight seal.

At least one of the first and second sides of the central hub may include a hosebarb to facilitate attachment to the at least one connection tube.

Furthermore, each of the plurality of mixing blades may be pitched at an angle to the plate section such that rotation of the blades in a clockwise direction forces a mixture to flow axially in a first direction, and rotation of the blades in a counterclockwise direction forces the mixture to flow axially in a second direction opposite the first direction. Alternatively, each of the plurality of mixing blades may be attached perpendicularly to the plate section such that rotation of the blades in a clockwise or counterclockwise direction forces a mixture to flow radially outward from the blades.

The bore hole preferably defines a key surface adapted to slideably insert and rotatably couple to a drive shaft such that, when assembled, the impeller will spin with the drive shaft. In some embodiments of the invention, the bore hole has a hexagonal cross-section. Preferably, the plate section is circular, and the bore hole and plate section are concentric.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a modular mixing impeller having straight blades, in accordance with an embodiment of the invention;

FIG. 2 is a plan view of a modular mixing impeller having pitched blades, in accordance with an embodiment of the invention:

FIG. 3 is a perspective view of a modular mixing impeller having pitched blades and multiple openings in the plate section, in accordance with an embodiment of the invention:

FIG. 4 is a perspective view of a modular mixing impeller assembly, constructed in accordance with an embodiment of the invention:

FIG. 5 is a perspective view of the modular mixing impeller assembly with drive shaft, constructed in accordance with an embodiment of the invention:

FIG. 6 is a plan view of the modular mixing impeller assembly with drive shaft and motor in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

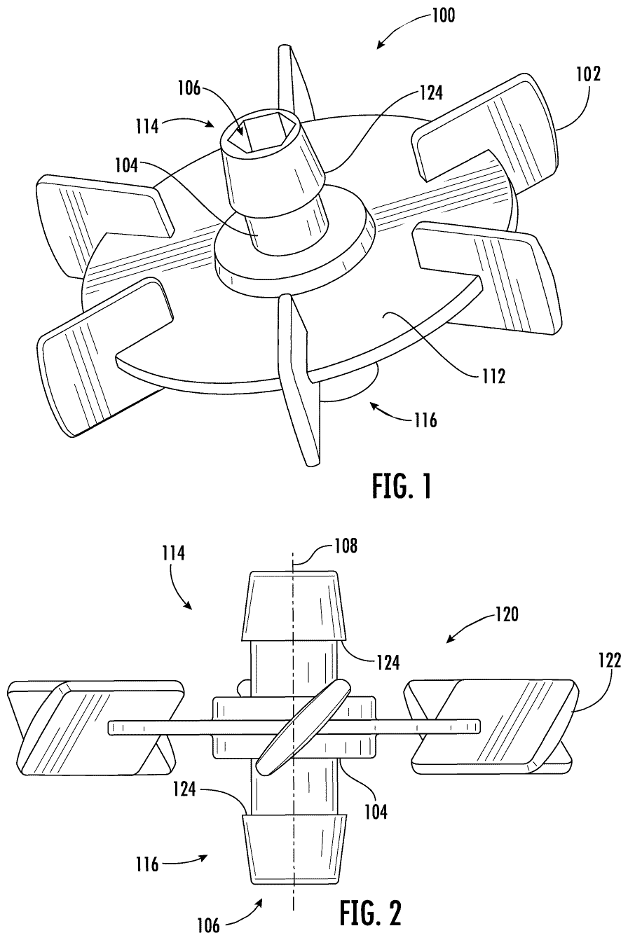

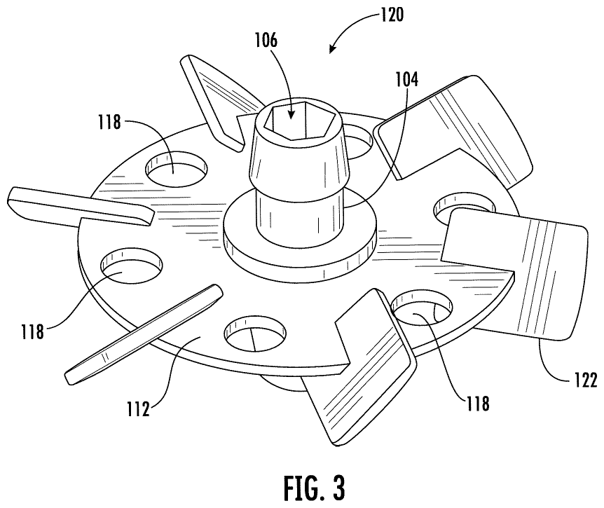

FIG. 1 is a perspective view of a modular mixing impeller 100 having straight blades 102, in accordance with an embodiment of the invention, while FIGS. 2 and 3 show respective plan and perspective views of a modular mixing impeller 120 having pitched blades 122, in accordance with an embodiment of the invention. Both modular mixing impellers 100, 120 include a central hub 104. The central hub 104 has a bore hole 106 with a longitudinal axis 108 such that the bore hole 106 passes axially through the central hub 104. As used in this application, the term “axially” refers to a direction along, or parallel to, the longitudinal axis 108, while the term “radially” refers to any direction that passes through, and is perpendicular to, the longitudinal axis 108.

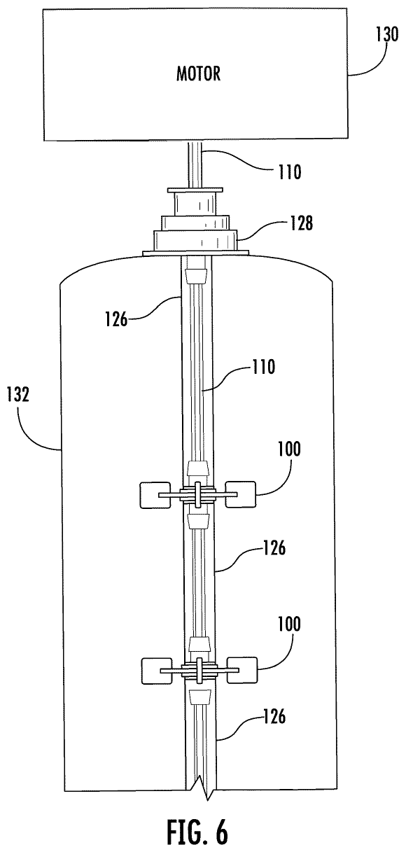

The bore hole 106 is configured to accommodate a drive shaft 110 (shown in FIGS. 5 and 6). In embodiments of the invention, the bore hole 106 has a hexagonal cross-section and is configured for assembly on a drive shaft 110 with a hexagonal cross-section, such that rotation of the drive shaft 110 causes a similar rotation of each modular mixing impeller 100, 120 assembled to the drive shaft 110. Alternatively, the bore hole 106 and drive shaft 110 could be rectangular, pentagonal, octagonal, or any suitable shape (e.g., oval, elliptical, etc.) which would facilitate assembly and rotation of the two components. Any of these provide a non-circular key shape that is slideable and rotatably coupleable, and may be used in any other embodiments.

As shown in FIGS. 1-3, the modular mixing impellers 100, 120 each include a plate section 112 that extends radially outward from the central hub 104, and the plurality of mixing blades 102, 122 is attached at a perimeter portion of the plate section 112. In particular embodiments of the invention, the plate section 112 has a one or more openings 118. For example, the plate section 112 may have three openings 118 spaced 120 degrees apart around a circumference of the plate section 112, or four openings 118 spaced 90 degrees apart around the circumference of the plate section 112, or, as shown in FIG. 3, six openings 118 spaced 60 degrees apart around the circumference of the plate section 112. In some configurations, the plate section 112 is circular and concentric with the bore hole 106.

As shown in FIG. 1, the plurality of straight blades 102 is attached so that each is arranged perpendicularly to the plate section 112. In the embodiment shown, the straight blades 102 extend from the perimeter of the plate section 112 some distance radially inward while also extending some distance radially outward from the plate section 112. In a mixing application with this straight blade arrangement, rotation of the blades 102 in a clockwise or counterclockwise direction forces a mixture to flow radially outward from the blades 102. This straight blade arrangement pushes the surrounding mixture straight out against the walls of the container creating a radial flow within the container. This style is typically applied when the mixing needs require dispersion or emulsion of the materials.

The impeller 120 of FIGS. 2 and 3 show pitched blades 122 attached so that each is arranged at some non-normal angle to the top and bottom surface of the plate section 112. The pitched blades 122 also extend from the perimeter of the plate section 112 some distance radially inward while also extending some distance radially outward from the plate section 112. As a result of this pitched angle arrangement, in a mixing application, rotation of impeller 120 and pitched blades 122 in a clockwise direction forces the mixture to flow axially in a first direction, and rotation of the blades 122 in a counterclockwise direction forces the mixture to flow axially in a second direction opposite the first direction.

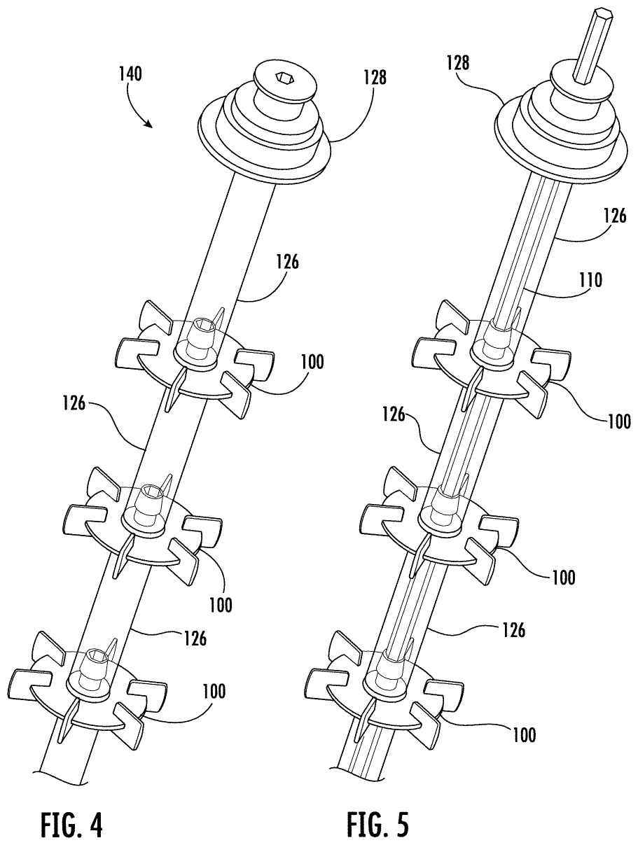

As also shown in FIGS. 1-3, the modular mixing impellers 100, 120 each show the central hub 104 with a first side 114 that extends axially away from the plurality of mixing blades 102, 122 in a first direction, and a second side 116 of the central hub 104 extends away from the plurality of mixing blades 102, 122 in a second direction opposite the first direction. As will be explained in more detail below, one or both of the first and second sides 114, 116 of the central hub 104 may include a hosebarb 124 to facilitate attachment to a connection tube 126 (shown in FIGS. 4 and 5).

FIG. 4 is a perspective view of a modular mixing impeller assembly 140, constructed in accordance with an embodiment of the invention. In the embodiment shown, the modular mixing impeller assembly 140 includes a plurality of modular mixing impellers 100, each connected to and adjacent modular mixing impeller 100 via a connection tube 126. In certain embodiments, each of the connection tubes 126 is made from a flexible material, such as plastic or a similarly flexible material. In other embodiments, each of the connection tubes 126 is made from a transparent material allowing the user to see if material inadvertently gets inside of the tube so as to come into contact with the drive shaft 110 (shown in FIGS. 5 and 6).

As mentioned above, the connection tubes 126 may be configured to be attached to the first or second axially-extending sides 114, 116 of the central hub 104. The aforementioned hosebarbs 124 on the axially-extending sides 114, 116 facilitate an airtight and water-tight attachment of the impeller 100, 120 to the connection tube 126. Thus, in certain embodiments, the first and second sides 114, 116 of the central hub 104 are each configured for assembly to the at least one connection tube 126 via a friction fit such that the impeller 100, 120 is configured to rotate with the at least one connection tube 126, and wherein the assembly between impeller 100, 120 and connection tube 126 creates an airtight and water-tight seal.

As explained above, for certain applications, the modular mixing impeller assembly 140 is sealed in a manner sufficient to prevent exterior contaminants from entering the mixing chamber location where product resides. A bottom end of the modular mixing impeller assembly 140 can be enclosed through various methods, two of which are described below.

To maintain the aforementioned airtight and water-tight seal so that the mixture does not come into contact with the drive shaft 110 or any other contaminants, the bottom end of the modular mixing impeller assembly 140 may be sealed by attaching a short length of tubing to the last impeller 100, 120 in the assembly 140. The open end of the short length of tubing (i.e., the end not attached to the hosebarb 124 of the impeller 100, 120) would then be closed off by inserting a tube plug. Alternatively, the bottom seal could be implemented using a short length of silicone tubing subjected to an overmolding process during which one of its open ends is filled in with liquid/gel-like silicone and cured in place to close off that end of the tubing. The remaining open end of the tube would then be fastened to the bottom-most impeller 100, 120 to seal off the assembly 140.

In particular embodiments of the invention, the length of the plurality of connection tubes 126 is variable such that the number of impellers 100, 120, which could be used for a given mixing application, can be increased or decreased by varying the length of the one or more connection tubes. For example, shortening the length of the would allow a user to add more impellers 100, 120 in a mixing bowl of a particular size. Connection tubes 126 of different lengths could be used in a single application to vary the spacing between impellers 100, 120.

The embodiment of FIG. 4 shows the plurality of impellers 100, 120 arranged in a series configuration, with each impeller disposed in axial spaced relation to an adjacent mixing blade. In such an arrangement, a length of the sealed tube may be variable such that the modular mixing impeller assembly can be configured to include a variable number of impellers.

FIG. 5 is a perspective view of the modular mixing impeller assembly 140 with the drive shaft 110, constructed in accordance with an embodiment of the invention. As shown, the drive shaft 110 is inserted through the one or more connection tubes 126 and through the bore hole 104 of each of the impellers 100, 120. The drive shaft 110 is configured for connection to an external motor 130 (shown in FIG. 6) that rotates the drive shaft 110. As explained above, the drive shaft 110 may have a hexagonal cross-section (though other cross-sectional shapes are contemplated, as also explained above) that corresponds to a hexagonal cross-section for each bore hole 104 of the one or more impellers 100, 120 such that rotation of the drive shaft 110 rotates each of the one or more impellers 10, 120, and also each of the one or more connection tubes 126.

FIG. 6 is a plan view of the modular mixing impeller assembly 140 with the drive shaft 110 and motor 130, constructed in accordance with an embodiment of the invention. As shown, the modular mixing impeller assembly 140 is disposed in a mixing container 132. At the top end of the modular mixing impeller assembly 140, the top-most connection tube 126 is attached to a metal shaft inside of a bearing assembly 128 (also shown in FIGS. 4 and 5) attached at the top of the mixing container 132. The drive shaft 110 is inserted through an opening in the bearing assembly 128 and through each of the connection tubes 126 and impellers 100, 120 in the modular mixing impeller assembly 140. In the embodiment shown, the bearing assembly 128 does not rotate with the drive shaft 110, like the connection tubes 126 and impellers 100, 120, which rotate in unison with the drive shaft 110.

The modular mixing impeller assembly 140 disclosed herein may be suspended from a mixing hub or sealed bearing 128, and can be built directly into a single-use container to maintain its interior sterility. Being capable of individual- or multiple-impeller configurations via variable lengths of connection tubes 126, the modular impellers 100, 120 are capable of meeting the needs of a variety of different mixing applications. The impellers 100, 120 are designed to mate with a drive shaft 110 that connects each impeller 100, 120 to a motor 130 outside of the mixing container 132 so that each impeller 100, 120 can be spun. In a typical embodiment, the mixing rod is inserted through the mixing hub or attached bearing, prior to operation, and slid through the center of the modular mixing impeller assembly 140. This ensures that the drive shaft 110 and any external contaminants do not come into contact with the contents of the mixing container 132.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A modular mixing impeller assembly comprising:
one or more connection tubes;
one or more impellers configured for assembly to the one or more connection tubes, each of the one or more impellers having a plurality of mixing blades, wherein each of the one or more impellers is assembled onto at least one connection tube via a friction fit such that each of the one or more impellers is configured to rotate with the at least one connection tube to which that impeller is assembled, and wherein the assembly between impeller and connection tube creates an airtight and water-tight seal.

2. The modular mixing impeller assembly of claim 1, wherein each of the one or more impellers includes a central hub with a bore hole therethrough, the bore hole configured to accommodate a drive shaft.

3. The modular mixing impeller assembly of claim 2, wherein a first side of the central hub extends axially away from the plurality of mixing blades in a first direction, and a second side of the central hub extends away from the plurality of mixing blades in a second direction opposite the first direction.

4. The modular mixing impeller assembly of claim 3, wherein the first side of the central hub includes a hosebarb to facilitate attachment to one of the one or more connection tubes.

5. The modular mixing impeller assembly of claim 3, wherein the second side of the central hub includes a hosebarb to facilitate attachment to one of the one or more connection tubes.

6. The modular mixing impeller assembly of claim 2, wherein at least one of the one or more impellers includes a plate section that extends radially outward from the central hub, and wherein each of the plurality of mixing blades is attached at a perimeter portion of the plate section.

7. The modular mixing impeller assembly of claim 6, wherein each of the plurality of mixing blades is pitched at an angle to the plate section such that rotation of the blades in a clockwise direction forces a mixture to flow axially in a first direction, and rotation of the blades in a counterclockwise direction forces the mixture to flow axially in a second direction opposite the first direction.

8. The modular mixing impeller assembly of claim 6, wherein each of the plurality of mixing blades is attached perpendicularly to the plate section such that rotation of the blades in a clockwise or counterclockwise direction forces a mixture to flow radially outward from the blades.

9. The modular mixing impeller assembly of claim 6, wherein the plate section has one or more openings.

10. The modular mixing impeller assembly of claim 9, wherein the plate section has three openings spaced 120 degrees apart around a circumference of the plate section, or four openings spaced 90 degrees apart around the circumference of the plate section, or six openings spaced 60 degrees apart around the circumference of the plate section.

11. The modular mixing impeller assembly of claim 1, wherein each pair of adjacent impellers is connected via a separate connection tube.

12. The modular mixing impeller assembly of claim 11, wherein a length of the one or more connection tubes is variable such that a number of impellers used, for a given application, can be increased or decreased by varying the length of the one or more connection tubes.

13. The modular mixing impeller assembly of claim 1, wherein the one or more impellers is a plurality of impellers arranged in a series configuration, with each impeller disposed in axial spaced relation to an adjacent mixing blade.

14. The modular mixing impeller assembly of claim 1, wherein a length of the sealed tube is variable such that the modular mixing impeller assembly can be configured to include a variable number of impellers.

15. The modular mixing impeller assembly of claim 1, further comprising a drive shaft inserted through the one or more connection tubes and through a bore hole of each of the one or more impellers, the drive shaft configured for connection to an external motor that rotates the drive shaft.

16. The modular mixing impeller assembly of claim 1, wherein the drive shaft has a hexagonal cross-section that corresponds to a hexagonal cross-section for each bore hole of the one or more impellers such that rotation of the drive shaft rotates each of the one or more impellers, and each of the one or more connection tubes.

17. The modular mixing impeller assembly of claim 1, wherein at least one of the one or more connection tubes is made from a flexible material.

18. The modular mixing impeller assembly of claim 17, wherein the flexible material is plastic.

19. The modular mixing impeller assembly of claim 1, wherein at least one of the one or more connection tubes is made from a transparent material.

20. The modular mixing impeller assembly of claim 1, further comprising a plurality of impellers arranged in a series configuration, each in axial spaced relation to an adjacent impeller, wherein each adjacent pair of impellers is connected via a separate connection tube.

21. A modular mixing impeller comprising:
a central hub with a bore hole therethrough, the bore hole configured to accommodate a drive shaft, the central hub configured for a sealed connection to at least one connection tube;
a plate section that extends radially outward from the central hub; and
a plurality of mixing blades attached at a perimeter portion of the plate section.

22. The modular mixing impeller of claim 21, wherein a first side of the central hub extends axially away from the plurality of mixing blades in a first direction, and a second side of the central hub extends away from the plurality of mixing blades in a second direction opposite the first direction.

23. The modular mixing impeller of claim 22, wherein the first and second sides of the central hub are each configured for assembly to the at least one connection tube via a friction fit such that the impeller is configured to rotate with the at least one connection tube, and wherein the assembly between impeller and connection tube creates an airtight and water-tight seal.

24. The modular mixing impeller of claim 22, wherein at least one of the first and second sides of the central hub includes a hosebarb to facilitate attachment to the at least one connection tube.

25. The modular mixing impeller of claim 21, wherein each of the plurality of mixing blades is pitched at an angle to the plate section such that rotation of the blades in a clockwise direction forces a mixture to flow axially in a first direction, and rotation of the blades in a counterclockwise direction forces the mixture to flow axially in a second direction opposite the first direction.

26. The modular mixing impeller of claim 21, wherein each of the plurality of mixing blades is attached perpendicularly to the plate section such that rotation of the blades in a clockwise or counterclockwise direction forces a mixture to flow radially outward from the blades.

27. The modular mixing impeller of claim 21, wherein the bore hole has a hexagonal cross-section.

28. The modular mixing impeller of claim 21, wherein the plate section is circular and wherein the bore hole and plate section are concentric.
